(19) United States
(12) Patent Application Publication
(10) Pub. No.: US 2003/0227485 A1
(43) Pub. Date: Dec. 11, 2003

(54) Method and apparatus for controlling and receiving data from connected devices

(76) Inventors: Haig H. Krakirian, Burbank, CA (US); Daniel T. Ward, Los Angeles, CA (US); Glen E. Roe, Simi Valley, CA (US); Geoffrey Z. Ombao, Los Angeles, CA (US)

Correspondence Address: DVA / PIONEER DIGITAL TECHNOLOGIES, SUITE 200, 2355 MAIN STREET, IRVINE, CA, 92614, US

(21) Appl. No.: 10/065,338

(22) Filed: Oct. 4, 2002

Related U.S. Application Data
(60) Provisional application No. 60/388,179, filed on Jun. 11, 2002.

(51) Int. Cl. G09G 5/00

(52) U.S. Cl. 345/771

(57) ABSTRACT

In accordance with the present invention, one or more devices are connected to a set-top box that is coupled to a television screen or other output device. A GUI is provided which allows a user to easily control the connected device by sending them control signals. The control signals cause the connected device to enter a new state. For instance if the connected device is a light and the light is off, the new state is on. In one embodiment the user accesses the GUI and defines events and rules associated with one of the connected devices. The set-top box in conjunction with the connected device then determines if the defined event has occurred. If it has, the rules are applied to the device and the device performs some action. In another embodiment, a portion of the device's action sends data to the GUI and provides some form of output to the user.

### CROSS REFERENCE TO RELATED APPLICATIONS

This Application claims priority to Provisional Patent Application serial No. 60/388,179, filed on Jun. 11, 2002, and herein incorporates that application by reference in its entirety.

### COPYRIGHT STATEMENT

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF INVENTION

1. Field of the Invention

The present invention relates generally to the control of connected devices, and more particularly, to a method and apparatus that enables a user to control and to receive data from connected devices.

2. Background of the Invention

It is desirable to operate numerous connected devices from one location. For instance, it is common to see a switch plate on the wall of a typical home residence where the switch plate has multiple switches. One might be for turning the kitchen lights on and off, while another might operate a fan over the living room table, while another might be a dimmer for track lighting in the next room. The benefit that comes from having a single interface to control multiple connected devices has expanded lately.

Now through the use of computers, many devices including: media players such as VCRs and DVDs, security cameras, lights, heating and air conditioning units, and numerous other devices can be connected using a single interface. It is difficult to operate such an interface, however. This problem is discussed in further detail below.

Interface for Connected Devices

When connecting multiple devices around the home for control at a central location, a computer, such as a PC or MAC, is typically used in the prior art as the central device that controls output to the devices. For instance, if a user wants to turn off the exterior lights in the back yard, they would provide input to the computer, either by pressing a key on a keyboard, using a mouse, or utilizing a remote control. That action provides a signal to the computer, which in turn sends a signal to the connected device, either across a wire or via a wireless connection. The result is that the device is controlled from the computer, either by turning it on or off, or providing some other meaningful command to the device.

One problem with this method is that it is inaccessible to many consumers, simply because they do not own an appropriate computer capable of managing such an interface with connected devices. Another problem with this prior art manner in which connected devices are controlled, is that each computer is different and each interface that works with the computer is different. This creates a great deal of work for the consumer in learning how to set-up the interface on the computer. This might entail, downloading software, installing data onto the computer, reading manuals, diagnosing problems, calling customer support hotlines, and the like. Many consumers do not have the expertise needed to perform these steps, which are required to get the system up and running.

Moreover, even if the consumer does have the ability to master a specific interface on a computer for controlling connected devices, most consumers will not do it simply because of the work involved in the process. There is an unconscious cost, benefit analysis that a consumer goes through. If the work needed to set the system up in the first place and to manage it exceeds the effort needed to simply get up out of a chair and flip the switch on the wall, then the consumer will opt for the latter. For this reason, prior art interfaces for controlling connected devices have been largely unsuccessful.

### SUMMARY OF INVENTION

The present invention is a method and apparatus for controlling and receiving data from connected devices. According to the present invention, one or more devices are connected to a set-top box that is coupled to a television screen or other output device. A GUI is provided which allows a user to easily control the connected device by sending them control signals. The control signals cause the connected device to enter a new state. For instance if the connected device is a light and the light is off, the new state is on.

According to one embodiment, the GUI resides in a partitioned screen that devotes one partition to broadcast programming and another partition to the GUI. In one embodiment the user accesses the GUI and defines events and rules associated with one of the connected devices. The set-top box in conjunction with the connected device then determines if the defined event has occurred. If it has, the rules are applied to the device and the device performs some action.

In another embodiment, a portion of the device's action sends data to the GUI and provides some form of output to the user. For example, the user is able to configure the layout of their home or office and where the connected devices reside within the layout. Then, when the connected device performs an action (e.g., a light is switched on at a pre-determined time), the device provides a signal to the set-top box, which causes the GUI to activate an indicator that informs the user that the device has performed the action (e.g., a light bulb appears within the user defined layout).

### BRIEF DESCRIPTION OF DRAWINGS

The invention will be more fully understood by reference to the following drawings, which are for illustrative purposes only:

FIG. 1 is a functional block diagram of a set-top box.

FIG. 2 is a functional block diagram of a system according to an embodiment of the present invention.

FIG. 3 is a diagram showing a partitioned output device according to an embodiment of the present invention.

FIG. 4 is a diagram showing a Graphical User Interface (GUI) used by an embodiment of the present invention.

FIG. 5 is a flowchart showing the operation of an embodiment of the present invention.

FIG. 6 is a flowchart showing the operation of an embodiment of the present invention that uses events and rules.

FIG. 7 is a functional block diagram of an arrangement that uses bi-directional communication according to an embodiment of the present invention.

FIG. 8 is a flowchart showing the use of a bi-directional communication according to an embodiment of the present invention.

FIG. 9 is a diagram showing on example of how the GUI allows for the definition of events and rules.

FIG. 10 is a diagram of a remote control used by an embodiment of the present invention.

FIG. 11 is a GUI screen in set-up mode according to one embodiment of the present invention.

FIG. 12 is a flowchart showing the operation of an embodiment of the present invention after completing the set-up mode shown in FIG. 11.

FIG. 13 is a functional block diagram of a system architecture according to an embodiment of the present invention.

### DETAILED DESCRIPTION

The present invention is a method and apparatus for controlling and receiving data from connected devices. According to the present invention, one or more devices are connected to a set-top box that is coupled to a television screen or other output device. A GUI is provided which allows a user to easily control the connected device by sending them control signals. The control signals cause the connected device to enter a new state. For instance, if the connected device is an air conditioner that is currently off, the new state might be to turn on and set the fan to low.

Set-Top Box

A set-top box is used as a component in the overall system that constitutes the present invention. The set-top box connects to the output device, which facilitates the use of broadcast signals, such as live television signals, video on demand broadcasts, downloads of Internet content, viewing of web pages etc. The set-top box also connects to the external devices to be controlled. A GUI is provided, which is displayed on the output device and allows the user to control and the devices connected to the set-top box, typically using a remote control. The system is controlled by software, firmware, and hardware, which resides at least partially in the set-top box. The software or firmware may be instaled locally or downloaded from the Internet as needed when configuring new set-top boxes or when updating existing ones.

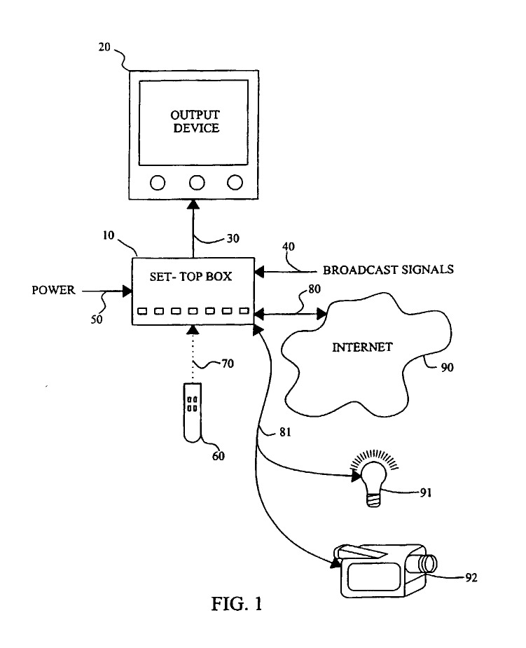

FIG. 1 is a functional block diagram that illustrates a system, which includes a set-top box 10 that is connected to a conventional output device 20 via a transmission line 30. Broadcast signals are received by the set-top box 10 via transmission line 40, which may be connected to either an antenna or a cable television outlet. Set-top box 10 receives power through a line 50. Set-top box 10 receives user input entered from a handheld remote control 60 over a wireless link 70. Wireless link 70 may be an infrared (IR) link, a radio frequency (RF) link, or any other suitable type of link. A bi-directional data path 80 is provided to set-top box 10, through which set-top box 10 can access the Internet 90. Connected devices 91 and 92 connect to set-top box 10 via bi-directional connection 81 wherein data may be passed from set-top box 10 to connected devices 91 and 92 or vice-versa.

Overall System

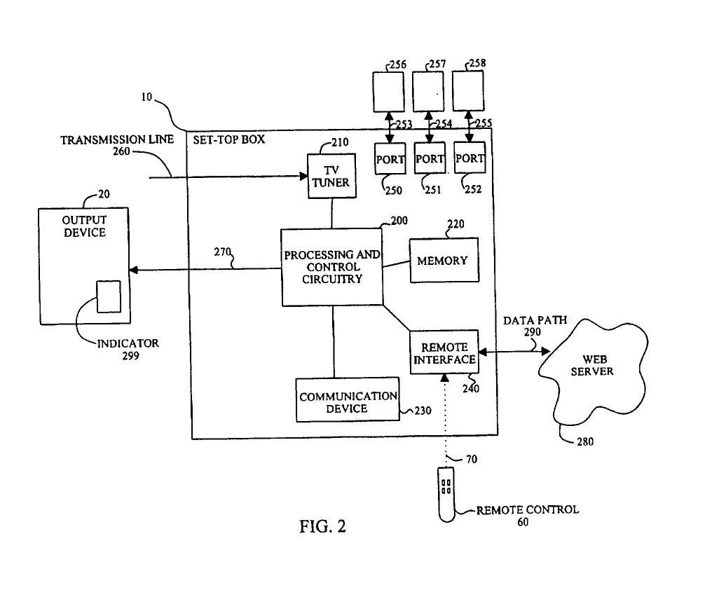

FIG. 2 is a functional block diagram that illustrates the components of an embodiment of the present invention. Note that FIG. 2 is intended to be a conceptual diagram and does not necessarily reflect the exact physical construction and interconnections of these components. Set-top box 10 includes processing and control circuitry 200, which controls the overall operation of the system. Coupled to the processing and control circuitry 200 is a TV tuner 210, a memory device 220, a communication device 230, and a remote interface 240. TV tuner 210 receives the television signals on transmission line 260, which may originate from an antenna or a cable television outlet. Processing and control circuitry 200 provides audio and video output to output device 20 via a line 270. Remote interface 240 receives signals from remote control 60 via wireless connection 70. Communication device 230 is used to transfer data between set-top box 10 and one or more remote processing systems, such as a web server 280, via a data path 290.

Processing and control circuitry 200 may include one or more of devices such as general-purpose microprocessors, digital signal processors (DSPs), application specific integrated circuits (ASICs), various types of signal conditioning circuitry, including analog-to-digital converters, digital-to-analog converters, input/output buffers, etc. Memory device 220 may include one or more physical memory devices, which may include volatile storage devices, non-volatile storage devices, or both. For example, memory 220 may include both random access memory (RAM), read-only memory (ROM), various forms of programmable and/or erasable ROM (e.g., PROM, EPOM, EEPROM, etc.), flash memory, or any combination of these devices.

Communication device 230 may be a conventional telephone (POTS) modem, an Integrated Services Digital Network (ISDN) adapter, a Digital Subscriber Line (xDSL) adapter, a cable television modem, or any other suitable data communication device. Ports 250, 251, and 252 are used to connect external devices to the set-top box. In this example there are three ports. Each port uses a bi-directional data connection 253, 254, and 255 to connect to external devices 256, 257, and 258. The connections 253, 254 and 255 can be wired connections or wireless connections and they allow data to pass both from the set-top box to the device and vice-versa. The Ports 253, 254, and 255 are USB ports, serial ports, RF wireless ports, or any other type of port capable of interfacing with an external device.

External device 256 is operated, for instance, by an input signal being presented by remote control 60 to remote interface 240 and then to port 253 via processing and control circuitry 200. The input signal is used to instruct external device 256 as to which operation to perform (i.e., turn on, turn off.) An indication 299 informing the user that the operation has been performed may be presented as output on device 20 via line 270. Alternatively, external device 257 can send signals across connection 254, through port 251 and to device 20 via line 270. Such a signal can be, for instance, in response to an event, such as a guest coming to the front door or the temperature in the house dropping below a pre-determined threshold. In that case, indication 298 appears on device 20.

Graphical User Interface (GUI)

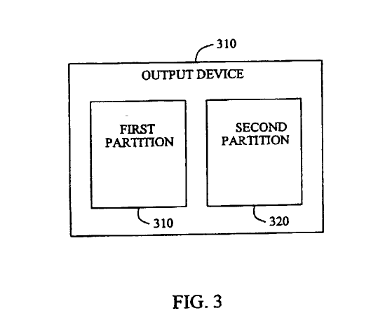

According to one embodiment, the GUI resides in a partitioned screen that devotes one partition to broadcast signals and another partition to the GUI. One example of the GUI is shown in the diagram of FIG. 3. Output device 300 can be a television set, a computer monitor, or other suitable output device. First partition 310 is devoted to broadcast signals. Broadcast signals include, for instance, live television signals, video on demand or pay-per-view broadcasts, internet web pages or downloads, and other content. Second partition 320 is devoted to the GUI for controlling and receiving data from connected devices. The first and second partition 310 and 320 are changeable in size and shape as desired by the user.

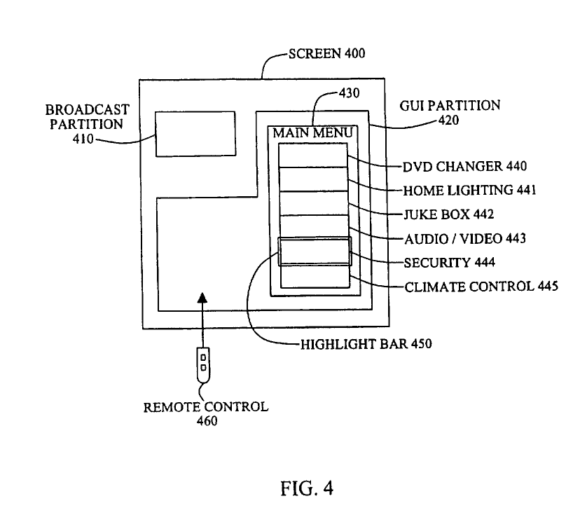

FIG. 4 is a diagram of a GUI for use with the present invention. Screen 400 includes a broadcast signal partition 410 and a GUI partition 420. GUI partition is currently at a main menu 430 which includes sections for a DVD changer 440, home lighting 441, Juke Box 442, Audio/Video 443, Security, 444, and Climate Control 445. The present selections are for purposes of example only. The present invention is not limited to such selections. The present invention may also include selections for controlling ovens, refrigerators, and microwaves, door locks, telephones, faxes, computers, and the like. The currently selected option is highlighted by a highlight bar 450. A remote control 460 is used to navigate the GUI partition 420. At a minimum, the remote control allows a user to scroll the list of items, select an item, to enter a set-up mode (for instance to add, delete, or configure devices), or to exit the menu.

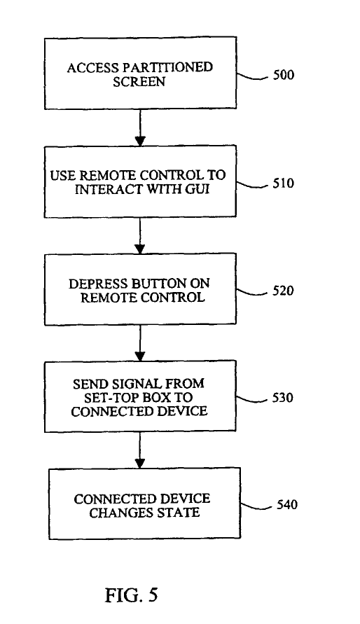

FIG. 5 is a flowchart showing how an embodiment of the present invention is used. At block 500, a user accesses a partitioned screen having at least a GUI and a broadcast signal. At block 510, the user uses a remote control to interact with the GUI. At block 520, the user depresses a button on the remote control, which causes the GUI to send a signal to a connected device at block 530 by sending data from the set-top box to the connected device. At block 540, the connected device changes state. For example, if the connected device is a light, then depressing the button at step 520 might cause the light to go from an on state to an off state.

Events and Rules

When the user enters set-up mode, there are a variety of GUI screens that are used that allow the user to customize the look and feel of the GUI as well as the actions that will be taken by the system. One aspect of the set-up mode is to define events and rules. Rules are instructions to the system that cause it to perform some action. Events are occurrences that will initiate the application of a rule. Events and rules make the system very flexible and allow it to have a different application in each location where such a system is implemented.

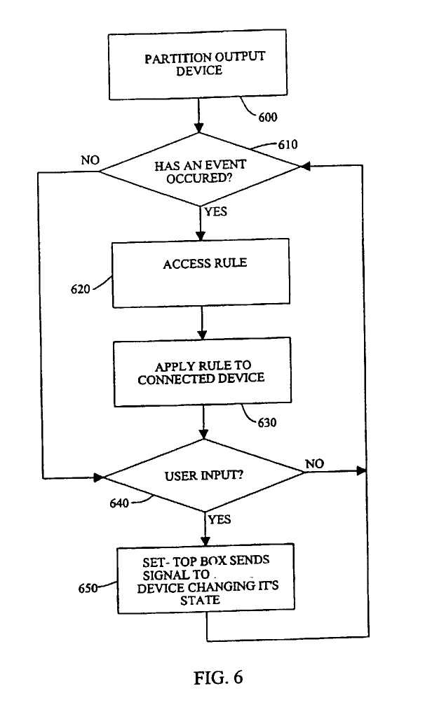

In one embodiment the user accesses the GUI and defines events and rules associated with one of the connected devices. The set-top box in conjunction with the connected device then determines if the defined event has occurred. If it has, the rules are applied to the device and the device performs some action. This embodiment is described generally by the flowchart shown in FIG. 6.

At step 600 an output device is partitioned wherein a first portion of the screen is dedicated to displaying a broadcast signal and wherein a second portion of the screen displays a GUI. At block 610, it is determined if an event has occurred. An event is a pre-defined activity that causes a connected external device to provide input to the system, to perform some action, and/or to change its state. If an event has occurred, the set-top box accesses a rule associated with the event at step 620. At step 630, the connected external device is sent a signal from the set-top box which applies the rule.

After step 630 or if no event has occurred at step 610, it is determined if the user has provided input to the system at step 640. The user providing input may be, for instance, a command to shut off a light somewhere in the building, or the activation of an intercom in the case where a guest has arrived at the front door. If the user is providing input to the system, then at step 650, a signal is sent from the set-top box to the external device causing it to change state. After step 650 or if step 640 is false, the process repeats at step 610.

Examples of typical events and rules associated with the events include the following:

If a security camera is a connected external device at the front door of a house, and a rule has been established that when any guest appears at the front door the camera should begin filming and send the images to the GUI, then a guest appearing at the front door is an event and the rule is to begin filming and present the images in a portion of the GUI.

If a heater and air conditioner is a connected external device, a temperature below a certain threshold is an event and the rule is to begin running the heater until another temperature is reached.

If a light at a front door is a connected device and the user wants the light to be turned on every night at 8:00 P.M, then a clock reaching 8:00 P.M. is the event and the rule is to turn on the light.

If the connected device is a media player such as a DVD or VCR, then a rule might be to record Friends every time it comes on the air. In this case, the event occurs when the set-top box determines Friends is about to air, in which case the rule is to begin recording with the media player on that channel.

If the connected device is an oven, and the user places dinner in the oven before work, then an event might be the clock reaching 6:00 P.M. and the rule would be to turn the oven on at 400 degrees for thirty minutes.

If a home sprinkler system is a connected device and the user wants the sprinklers to be turned on every other morning at 5:00 A.M, then a clock reaching 5:00 A.M. every other day is the event and the rule is to turn on the sprinklers.

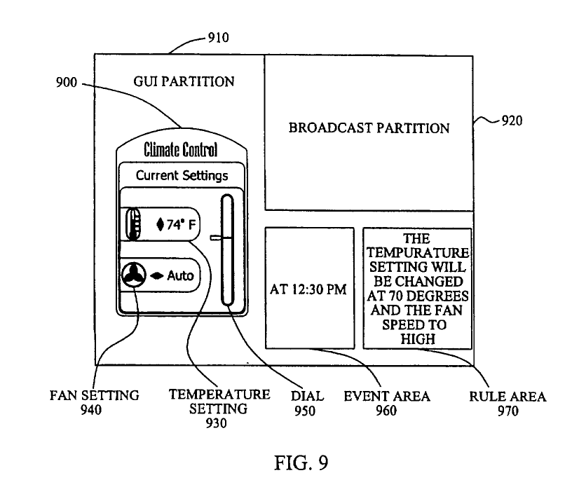

One example of how the GUI is used to define rules and events is shown in FIG. 9. Assume a user selected climate control from main menu 430 of FIG. 4. A climate control menu 900 appears as shown in FIG. 9. Climate control menu 900 resides in GUI partition 910 along with broadcast signal partition 920. GUI partition 910 includes at least a temperature setting 930, a fan setting 940, and a dial 950 that can be used to change the temperature. Event area 960 is used to indicate what events are defined for this device and rule area 970 is used to show what rules apply to the event.

In the current example, event area 960 and rule area 970 state that at 12:30 p.m. the temperature setting will be changed to 70 degrees and the fan speed to HIGH. So in this case, a rule for changing the temperature to 70 degrees and turning the fan to HIGH has been established and an event has been associated with this rule that instructs the system to watch an internal clock and when it reaches 12:30 P.M. the event has occurred so it should apply the rule. Note that event area 960 and rule area 970 need not be separate and may be members of one specific area in GUI partition 910.

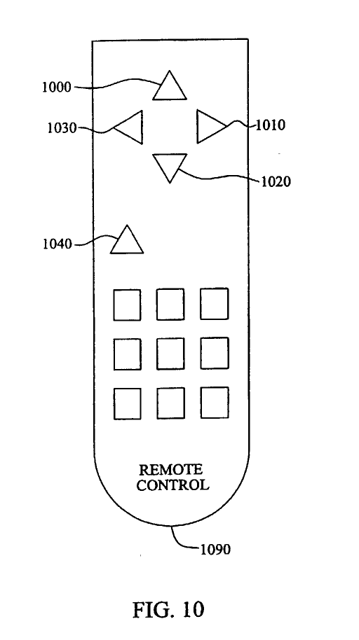

Events and rules are set up, for instance, using a remote control in connection with the GUI. FIG. 10 shows one example of a remote control that is used with an embodiment of the present invention. FIG. 10, in addition to providing the needed buttons to operate the television set includes navigation buttons 1000, 1010, 1020, and 1030. These buttons are used to move a highlight bar through the interface where a set-up option is selected. Alternatively, remote control 1090 can be used by depressing special button 1040. Special button 1040 has different applicability depending upon the screen currently viewed. In the context of setting up an event such as changing the interior temperature, the depression of special button 1040 brings a new screen that allows the user to define the event and apply the rules to the event.

Bi-Directional Communication

One aspect of the present invention is that the connected devices are able to provide signals as input to the set-top box, which in turn causes the GUI to display output to the user. For instance, one scenario is that a user wants to be alerted when someone comes to the front door of a house (an event). The rule might be that when this event happens, a camera at the front door is to begin filming and display the images on at least a portion of the GUI. This scenario requires a bi-directional communication because unlike an action to turn a light on or off, the event's occurrence must be determined external to the set-top box, and data must first pass from the connected device to the set-top box before processing occurs.

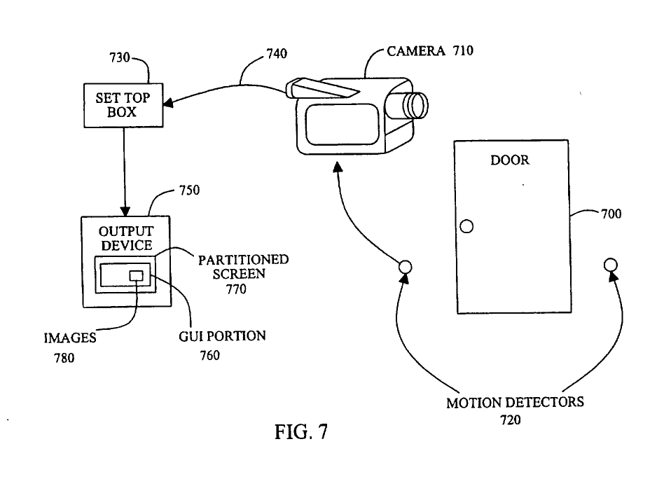

FIG. 7 is a functional block diagram of an arrangement that utilizes a bi-directional communication according to an embodiment of the present invention. Front door 700 has a camera 710 positioned at the front door. Motion detectors 720 are configured to sense the presence of a person at the front door. If the motion detectors sense such a presence, a signal is sent to set-top box 730. The set-top box determinesif the sensing of a person at the front door is an event. Assuming that it is, the camera 710 begins recording the images and transferring them across connection 740 to the set-top box 730. Output device 750 has a GUI portion 760 in a partitioned screen 770 where images 780 are displayed.

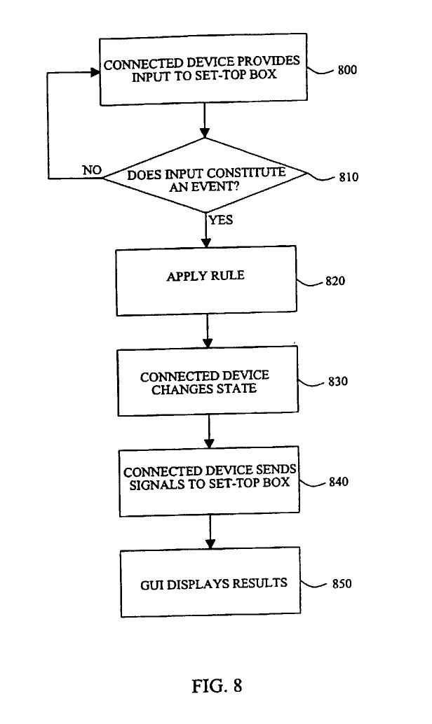

FIG. 8 is a flowchart showing the operation of a bi-directional communication mechanism according to an embodiment of the present invention. At block 800, a connected device provides input to a set-top box. At block 810, the set-top box determines if the input constitutes an event. If not, block 800 repeats. Otherwise, at block 820, the set-top box applies a rule to the same or another connected device. At block 830 the connected device changes state (i.e., it performs some action). At block 840, the connected device sends signals to the set-top box and at block 850, the GUI displays the results of the signals.

FIG. 8 generally describes the scenario shown in FIG. 7 as well as others. For instance, a user may want to conserve energy. To this end they may configure the system to initiate turning off lights in certain room when they have been left on for too long. Similarly, the user may wish to turn off a sprinkler system that has been left on for too long or to close a door that has been left open. This may occur, for instance, by the system automatically causing the connected device to change state (i.e., turning the sprinklers off or closing the door). Alternatively, the system may send an indicator to the GUI, which informs the user that the system thinks the device has erroneously been left on too long, which then allows the user to manually switch off the device if they choose.

Set-Up Mode

One aspect of set-up mode allows the user to customize the look and feel of the GUI. For instance, in the context of home lighting, the following customizations are permitted in set up mode:

The user is able to add or delete rooms from the system

The user is able to specify the layout of each room in the system; and

The user is able to specify the location of each light for each room in the system.

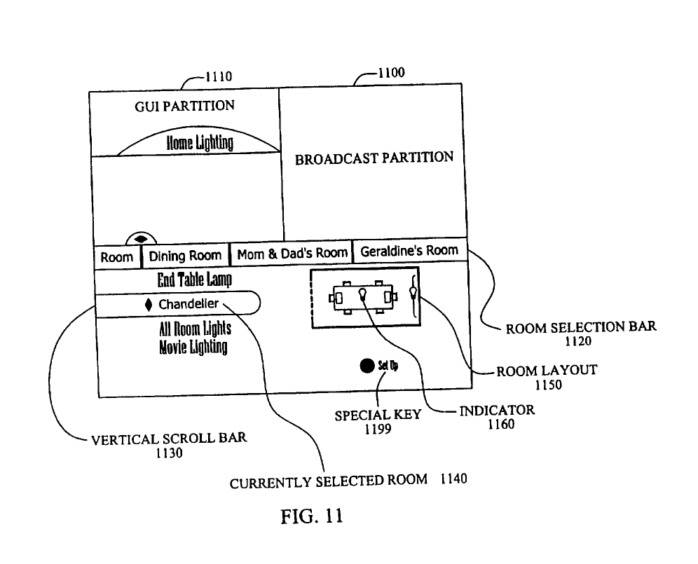

FIG. 11 shows a GUI screen in set-up mode according to one embodiment of the present invention. The screen includes a partition including a broadcast signal partition 1100 and a GUI partition 1110. The GUI partition has a configured room selection bar 1120. Configured room selection bar 1120 has all of the names of the rooms that have already been configured into the system. It includes vertical scroll bar 1130 with which a user is able to select each configured light in the currently selected room 1140. GUI partition 1110 also includes room layout 1150 that represents the physical characteristics of the room and indicator 1160, which is used to show which light in the room is currently on.

In the present example only one indicator 1160 is active, but multiple may be active simultaneously if multiple lights are in an on state in the same room. The remote control may be used to set up new rooms, for instance by activating special key 1199 with a remote control (not shown). If used in this manner, the user is prompted with a list of common layouts. The user then chooses the layout that is most similar to their room and proceeds to specify where the lights are as well as naming the room and specifying what each light is.

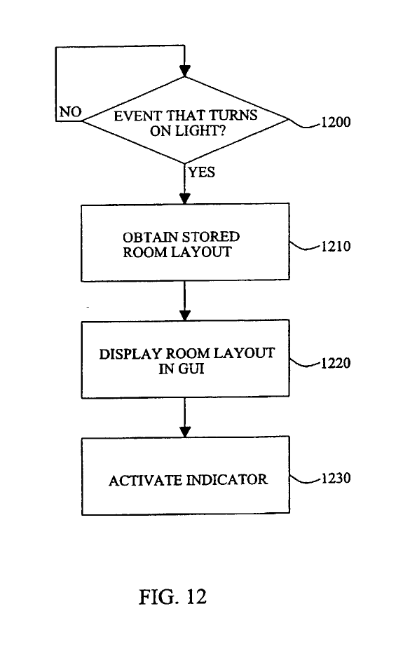

FIG. 12 is a flowchart showing how the present invention operates after rooms have been set up in accordance with FIG. 11. At block 1200, it is determined if an event that turns on a light has occurred. If not, block 1200 repeats. When block 1200 is true, the stored layout for the room is obtained at block 1210. At block 1220 the layout is displayed on the GUI. At block 1230 an indicator showing the light that was turned on is displayed in the GUI at the location where it resides in the room.

System Architecture

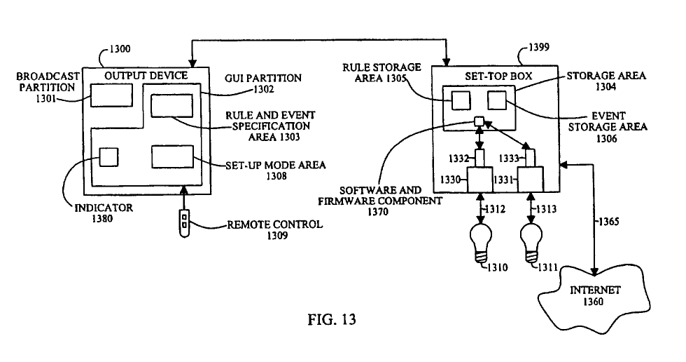

FIG. 13 shows the system architecture employed by one embodiment of the present invention. The output device 1300 includes a broadcast partition 1301 and a GUI partition 1302. The GUI partition 1302 includes a rule and event specification area 1303 where rules and events can be input to customize the system. GUI partition 1302 also includes a set-up mode area 1308, which is shown as a component of GUI partition 1302, however remote control 1309 is typically used to access set-up mode area 1308 as well as rule and event specification area 1303.

The rules and events are recorded in storage area 1304 in rule storage area 1305 and event storage area 1306. Storage area 1304 also includes a software and firmware component 1370, which handles the overall functionality of the system. GUI partition also includes indicator 1380, which generally refers to an area where data is transmitted from the connected device to the set-top box 1399. Indicator 1380 includes, for instance, images taken by a connected device such as a security camera or is indicative of a signal stating that a light or other device has changed state.

Connected devices 1310 and 1311 are connected to set-top box 1399 by bi-directional data connections 1312 and 1313. Ports 1330 and 1331 facilitate the connections and device drivers 1332 and 1333 interface with the data as it is transmitted from the connected devices across the connection and through the ports 1330 and 1331. The ports are any of those known to those skilled in the art, which are configured to interface with a connected device. These include, for instance, USB ports, serial ports, infrared ports, radio frequency ports, parallel ports, or other wired or wireless ports.

The device drivers arrange the data in a format that is acceptable to software and firmware component 1370. Internet 1360 is connected to set-op box 1399 via connection 1365, which can be a conventional phone line, a cable connection, a satellite connection, or any other connection known to those skilled in the art. A home or office may have multiple set-top boxes. In each set-top box software and firmware component 1370 that may be downloaded, changed, and updated, via an Internet connection 1360.

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. A method for interfacing with a device connected to a set-top box comprising:
accessing a graphical user interface (GUI) on a partitioned screen coupled to said set-top box;
selecting said connected device by accessing a menu in said GUI; and
sending a signal from said set-top box to said connected device wherein said signal causes said connected device to enter a new state.

2. The method of claim 1 wherein said new state is an on state.

3. The method of claim 1 wherein said new state is an off state.

4. The method of claim 1 wherein said connected device is a light.

5. The method of claim 1 wherein said connected device is a heater or an air conditioner.

6. The method of claim 1 wherein said connected device is a media player, such as a DVD or a VCR.

7. The method of claim 1 wherein said connected device is an audio player, such as a juke box or a radio.

8. The method of claim 1 wherein said connected device is a security device, such as a camera.

9. A method for interfacing with a device connected to a set-top box comprising:
accessing a graphical user interface (GUI) on a partitioned screen coupled to said set-top box;
defining an event in said GUI;
defining one or more rules related to said event in said GUI;
determining if said event has occurred;
applying said rules to said device with said set-top box, if said event has occurred.

10. The method of claim 9 wherein said step of determining further comprises using said connected device to determine the occurrence of said event.

11. The method of claim 9 wherein said step of determining further comprises using said set-top box to determine the occurrence of said event.

12. A method for interfacing with a device connected to a set-top box comprising:
accessing a graphical user interface (GUI) on a partitioned screen coupled to said set-top box;
defining a layout for a room in said GUI;
defining a location for a connected device in said layout using said GUI; and
receiving an indication in said GUI at said location in said layout, when said connected device changes a state.

13. The method of claim 12 wherein said connected device is a light.

14. The method of claim 12 wherein said state is an on state.

15. The method of claim 12 wherein said state is an off state.

16. The method of claim 11 wherein said event is a time, further comprising:
activating a clock in said set-top box; and
determining when said clock reaches said time.

17. The method of claim 10 wherein said event is a motion at a location and said connected device is a motion detector coupled to a camera, further comprising
activating said motion detector;
determining when said motion at said location occurs;
activating said camera; and
transmitting one or more images from said camera to said GUI via said set-top box.

18. An apparatus comprising:
a graphical user interface (GUI) on a partitioned screen coupled to a set-top box;
a connected device selected by accessing a menu in said GUI; and
a signal sent from said set-top box to said connected device wherein said signal causes said connected device to enter a new state.

19. The apparatus of claim 18 wherein said new state is an on state.

20. The apparatus of claim 18 wherein said new state is an off state.

21. The apparatus of claim 18 wherein said connected device is a light.

22. The apparatus of claim 18 wherein said connected device is a heater or an air conditioner.

23. The apparatus of claim 18 wherein said connected device is a media player, such as a DVD or a VCR.

24. The apparatus of claim 18 wherein said connected device is an audio player, such as a juke box or a radio.

25. The apparatus of claim 18 wherein said connected device is a security device, such as a camera or a camera coupled to motion detectors.

26. An apparatus comprising:
a graphical user interface (GUI) on a partitioned screen coupled to a set-top box;
an event defined by accessing said GUI;
one or more rules related to said event defined by accessing said GUI;
wherein said set-top box or a device connected to said set-top box determines if said event has occurred and, wherein said rules are applied to said device with said set-top box, if said event has occurred.

27. An apparatus comprising:
a graphical user interface (GUI) on a partitioned screen coupled to a set-top box;
a layout for a room defined by accessing said GUI;
a location for a connected device in said layout defined by accessing said GUI; and
an indication in said GUI received at said location in said layout, when a connected device changes a state.

28. The apparatus of claim 27 wherein said connected device is a light.

29. The apparatus of claim 27 wherein said state is an on state.

30. The apparatus of claim 27 wherein said state is an off state.

31. The apparatus of claim 26 wherein said event is a time, further comprising:
a clock activated in said set-top box; and
a mechanism to determine when said clock reaches said time.

32. The apparatus of claim 26 wherein said event is a motion at a location, further comprising
a motion detector configured to be activated when said motion at said location occurs;
said camera configured to be activated in response to said motion detector being activated; and
one or more images from said camera configured to be sent to said GUI via said set-top box when said camera is activated.
